(19) United States
(12) Patent Application Publication
(10) Pub. No.: US 2005/0271002 A1
(43) Pub. Date: Dec. 8, 2005

(54) Radio communication terminal, radio base station, and radio communication system

(75) Inventors: Shunsaku Abe, Yokohama (JP); Masao Hayama, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Communication Technologies, Inc., Tokyo (JP)

(21) Appl. No.: 11/040,685

(22) Filed: Jan. 21, 2005

(30) Foreign Application Priority Data
Jun. 8, 2004 (JP) 2004-169317

(51) Int. Cl. H04Q 7/00

(52) U.S. Cl. 370/328

(57) ABSTRACT

Actual calculated throughput is presented to the user before the start of communications. A transmission and receiving section of a radio communication terminal transmits a first signal to a radio base station while the radio communication terminal is in an idling state to request a second signal (such as null data) used to calculate a transfer rate (such as throughput) expected in communications, and receives the second signal transmitted by the radio base station in response to the first signal. When the second signal having the amount of information specified in advance is received, a signal processing section calculates the transfer rate according to the time required from the start of receiving of the second signal to when the amount of information is reached, and the amount of information of the second signal received. Alternatively, when the transmission end notice of the second signal is received from the radio base station, the signal processing section calculates the transfer rate according to the time required from the start of receiving of the second signal to when the transmission end notice is received, and the amount of information of the second signal received. The signal processing section displays the transfer rate on a display section.

### BACKGROUND OF THE INVENTION

1. Field of the Invention

The present invention relates to radio communication terminals, radio base stations, and radio communication systems, and more particularly, to a radio communication terminal, a radio base station, and a radio communication system for mobile radio communications.

2. Description of the Related Art

In addition to conventional wired communication networks, radio communication networks which use radio communication terminals and radio base stations have been rapidly introduced. Recently, code-division-multiple-access (CDMA) communication networks which code-multiplexes information such as sound with the use of spreading code to perform communications have been spread, allowing high-speed communications.

In a packet-data mobile communication system of an evolution-data-only (EV-DO) type specified by 3GGP2 (3GPP2 C. S0024 HRPD Air-Interface), a radio communication terminal of the user predicts a downstream communication rate (speed) which can be used in communications, from an radio-wave condition obtained when the user starts communication connection, requests the communication rate from a radio base station, and starts data communication.

In the radio communication network, however, since there are a plurality of radio communication terminals in a range called a sector where a radio base station can communicate with the plurality of radio communication terminals by radio waves, even when a radio communication terminal obtains a data request value (requested transmission rate), calculated from the level of a pilot signal received from the radio base station, an accurate data rate is obtained only after data communication to be charged is performed, because a data amount which is send from the radio base station at the requested rate is to be basis of calculating the data rate (amount of transmitting data).

This is because a slot of a downstream data link channel (or forward link channel from the base station to a terminal) is assigned to each user according to the data request value (requested transmission rate) sent from the radio communication terminal which is to start communications and the requested transfer rates sent from other radio communication terminals located in the range controlled by the same radio base station.

Therefore, the radio base station determines a data request value from the data request value (requested transmission rate) which is requested from the radio communication terminal and just starts sending data to the radio communication terminal. A technology is demanded which easily checks the state of a communication channel before the start of communications. The technology allows, for example, a radio communication terminal to calculate and display the data rate.

A technology for sending a data rate from a radio base station to the user before the user starts communications is disclosed (for example, in Japanese Unexamined Patent Application Publication No. Hei-11-331943). In this technology, estimated rate information is, for example, sent from the base station to a terminal through a paging channel. Further, a technology in which a base station estimates a data rate from the mobile information of a terminal and sends the rate to the terminal is disclosed (for example, in Japanese Unexamined Patent Application Publication No. 2002-353876).

The throughput (for example, the transfer rate and the communication rate) of each radio communication terminal is determined by not only the radio-wave environment of the radio terminal but also the number of radio communication terminals located in a range controlled by the same radio base station and the radio-wave environment of the radio communication terminals. It is difficult for the user to accurately estimate the throughput of a radio communication terminal from the intensity of a pilot signal received by the radio communication terminal and a data request value (requested transmission rate).

In the technologies disclosed in the above-described patent references, in which a data rate estimated before the start of communications is displayed, the data rate is not actually measured, and the data rate sent to a terminal is an estimate based on information at the base station.

In mobile communication systems which use packets and employ a best-effort-type time-division-multiplex method, typical of which is EV-DO-type packet data mobile communication systems, the data of one user (or terminal) is assigned to one slot in a time-division manner. The slot assignment is performed so as to make the throughput of a radio base station optimum according to forward-link data request value (requested transmission rates) sent from radio communication terminals. In best-effort-type data communication methods, such as the EV-DO-type data communication method, even when an radio-wave environment is displayed and an estimated data rate is obtained from the base station, the current throughput is always changing according to the number of users and the accesses of available idling terminals. Although a data rate is requested from the base station according to the radio-wave condition of a terminal, the actual data rate cannot be calculated. The methods are not always easy to use for the user.

### SUMMARY OF THE INVENTION

The present invention has been made in view of the foregoing points. Accordingly, it is an object of the present invention to provide a system in which a base station sends some data used to calculate the actual throughput in a radio communication network to a radio communication terminal, and the actual calculated throughput is presented to the user before the start of communications. Another object of the present invention is to allow a radio data rate (amount of transmitting data) to be measured by the radio-terminal user before communications in best-effort-type data communication methods typical of which is the EV-DO data communication method. Still another object of the present invention is to promote an efficient operation of data communication. Yet another object of the present invention is to allow the terminal user to check a radio data rate (amount of transmitting data) by the use of null-packet data without using regular data communication (communication to be charged).

In a best-effort-type mobile communication system, when a terminal requests a base station to display a radio data rate (amount of transmitting data), the base station transmits null packet data used to calculate the radio data rate (amount of transmitting data) to the mobile terminal, and the terminal calculates the data rate (amount of transmitting data) and displays it.

The mobile terminal always measures a radio-wave condition (C/I value) and can display a radio-wave level on the terminal. It is preferred that the base station transmit some data with the communication state and the number of other terminals in the same sector being taken into account. If data communication is actually performed, a data communication charge is imposed and traffic is increased. Therefore, it is not necessarily effective to always perform actual data communication.

When the user of the mobile terminal wants to calculate the current radio data rate (amount of transmitting data) (throughput) before starting data communication, the user sends a rate checking request from the terminal to the base station. The base station receives it, transmits null packet data to the terminal with the use of, for example, a vacant slot with the use condition of the sector being taken into account. The terminal calculates the throughput. The terminal displays the radio data rate (amount of transmitting data) to the user in a manner different from that of the radio-wave-condition indication, with a numeral, a figure, or a combination thereof.

A radio terminal according to the present invention includes signal transmission means for transmitting a predetermined signal to a radio base station while the terminal is in an idling state, receiving means for receiving a predetermined signal sent from the radio base station, signal processing means for calculating, when the receiving means has received the predetermined signal having the amount of information specified in advance, a transfer rate expected in communications, according to the time required to receive the amount of information, and display means for displaying the transfer rate calculated by the signal processing means.

Another radio terminal according to the present invention includes signal transmission means for transmitting a predetermined signal to a radio base station while the terminal is in an idling state, receiving means for receiving a predetermined signal sent from the radio base station, signal processing means for calculating, when a time specified in advance has elapsed from when the predetermined signal is received, a transfer rate expected in communications, according to the amount of information of the predetermined signal received by the time specified in advance, and display means for displaying the transfer rate calculated by the signal processing means.

A radio base station according to the present invention includes signal receiving means for receiving a first predetermined signal from a radio communication terminal, signal processing means for generating a second predetermined signal when the signal receiving means has received the first predetermined signal, and data transmission means for transmitting the second predetermined signal generated by the signal processing means to the radio communication terminal.

According to the first solving means of the present invention, a radio communication terminal is provided which comprises:
a transmission section for transmitting a first signal to a radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate a transfer rate expected when the radio communication terminal is connected to the radio base station through a radio communication path;
a receiving section for receiving the second signal or the plurality of second signals transmitted from the radio base station in response to the first signal; and
a signal processing section for calculating, when the receiving section has received the second signal or the plurality of second signals having the amount of information corresponding to the first signal, the transfer rate according to the time required from when receiving of the second signal is started to when the amount of information is reached, and the amount of information of the second signal received; or for calculating, when the receiving section has received an end notice of the transmission of the second signal from the radio base station, the transfer rate according to the time required from when receiving of the second signal is started to when the end notice of the transmission is received, and the amount of information of the second signal received.

According to the second solving means of the present invention, a radio communication terminal is provided which comprises:
a transmission section for transmitting a first signal to a radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate a transfer rate expected when the radio communication terminal is connected to the radio base station through a radio communication path;
a receiving section for receiving the second signal or the plurality of second signals transmitted from the radio base station in response to the first signal; and
a signal processing section for calculating, when a time specified in advance has elapsed from when the receiving section starts receiving the second signal, the transfer rate according to the amount of information of the second signal received until the time specified in advance elapses, and the time specified in advance.

According to the third solving means of the present invention,
a radio base station in a radio communication system in which a data area for storing communication data is formed of a plurality of slots time-divided, data or a signal to be sent to each radio communication terminal is assigned to a slot, and the radio base station transmits data or a signal to each radio communication terminal, the radio base station for calculating a transfer rate expected when a radio communication terminal in an idling state is connected to the radio base station through a radio communication path, the radio base station comprising:
a receiving section for receiving a first signal from the radio communication terminal, the first signal requesting the transmission of a second signal used to calculate the transfer rate expected when the radio communication terminal is connected to the radio base station through the radio communication path;
a signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the receiving section has received the first signal; and
a transmission section for transmitting the second signal or a plurality of second signals generated by the signal processing section to the radio communication terminal, is provided.

According to the fourth solving means of the present invention,
a radio communication system in which a data area for storing communication data is formed of a plurality of slots time-divided, data or a signal to be sent to each radio communication terminal is assigned to a slot, and a radio base station transmits data or a signal to each radio communication terminal, the radio communication system for calculating a transfer rate expected when a radio communication terminal in an idling state is connected to the radio base station through a radio communication path,
the radio communication terminal comprising:
a first transmission section for transmitting a first signal to the radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate the transfer rate expected when the radio communication terminal is connected to the radio base station through the radio communication path;
a first receiving section for receiving the second signal or the plurality of second signals transmitted from the radio base station in response to the first signal; and
a first signal processing section for calculating, when the first receiving section has received the second signal or the plurality of second signals having the amount of information corresponding to the first signal, the transfer rate according to the time required from when receiving of the second signal is started to when the amount of information is reached, and the amount of information of the second signal received; or for calculating, when the first receiving section has received an end notice of the transmission of the second signal from the radio base station, the transfer rate according to the time required from when receiving of the second signal is started to when the end notice of the transmission is received, and the amount of information of the second signal received, and
the radio base station comprising:
a second receiving section for receiving the first signal from the radio communication terminal, the first signal requesting the transmission of the second signal;
a second signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the second receiving section has received the first signal; and
a second transmission section for transmitting the second signal or a plurality of second signals generated by the second signal processing section to the radio communication terminal, is provided.

According to the fifth solving means of the present invention,
a radio communication system in which a data area for storing communication data is formed of a plurality of slots time-divided, data or a signal to be sent to each radio communication terminal is assigned to a slot, and a radio base station transmits data or a signal to each radio communication terminal, the radio communication system for calculating a transfer rate expected when a radio communication terminal in an idling state is connected to the radio base station through a radio communication path,
the radio communication terminal comprising:
a first transmission section for transmitting a first signal to the radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate the transfer rate expected when the radio communication terminal is connected to the radio base station through the radio communication path;
a first receiving section for receiving the second signal or the plurality of second signals transmitted from the radio base station in response to the first signal; and
a first signal processing section for calculating, when a time specified in advance has elapsed from when the first, receiving section starts receiving the second signal, the transfer rate according to the amount of information of the second signal received until the time specified in advance elapses, and the time specified in advance, and
the radio base station comprising:
a second receiving section for receiving the first signal from the radio communication terminal, the first signal requesting the transmission of the second signal;
a second signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the second receiving section has received the first signal; and
a second transmission section for transmitting the second signal or a plurality of second signals generated by the second signal processing section to the radio communication terminal, is provided.

According to the present invention, a radio base station is made to send to a radio communication terminal some data used to calculate actual throughput in a radio communication network, and the actual calculated throughput can be presented to the user before the start of communications. In addition, according to the present invention, a radio data rate (amount of transmitting data) can be measured before communications made by the radio-terminal user in a best-effort-type data communication method typical of which is the EV-DO method. Further, according to the present invention, an efficient operation of data communication can be promoted. Furthermore, according to the present invention, the terminal user can check a radio data rate (amount of transmitting data) with the use of null packet data without using regular data communication (subjected to accounting).

### BRIEF DESCRIPTION OF THE DRAWINGS

FIG. 1 is a structural view of a system according to an embodiment of the present invention.

FIG. 2 is a frame structural view in a downstream data channel.

FIG. 3 is a block diagram of a radio communication terminal (AT).

FIG. 4 is a block diagram of a radio base station (AP).

FIG. 5 is a structural view of the system shown in FIG. 1 to which a radio communication terminal is added.

FIG. 6 is an operational flowchart of processing performed between an AT and an AP with a null-data size being fixed.

FIG. 7 is an operational flowchart of processing performed between an AT and an AP with a null-data size being variable.

FIG. 8 is a flowchart of professional-fair scheduling algorithm.

FIG. 9 shows an example display of throughput at an AT.

FIG. 10 shows an example structure of a DRC table.

FIG. 11 is an operational flowchart of modified processing performed between an AT and an AP.

FIG. 12 is a view typically showing example packets with slots.

FIG. 13 is a view typically showing another example packets with slots.

### DESCRIPTION OF THE PREFERRED EMBODIMENTS

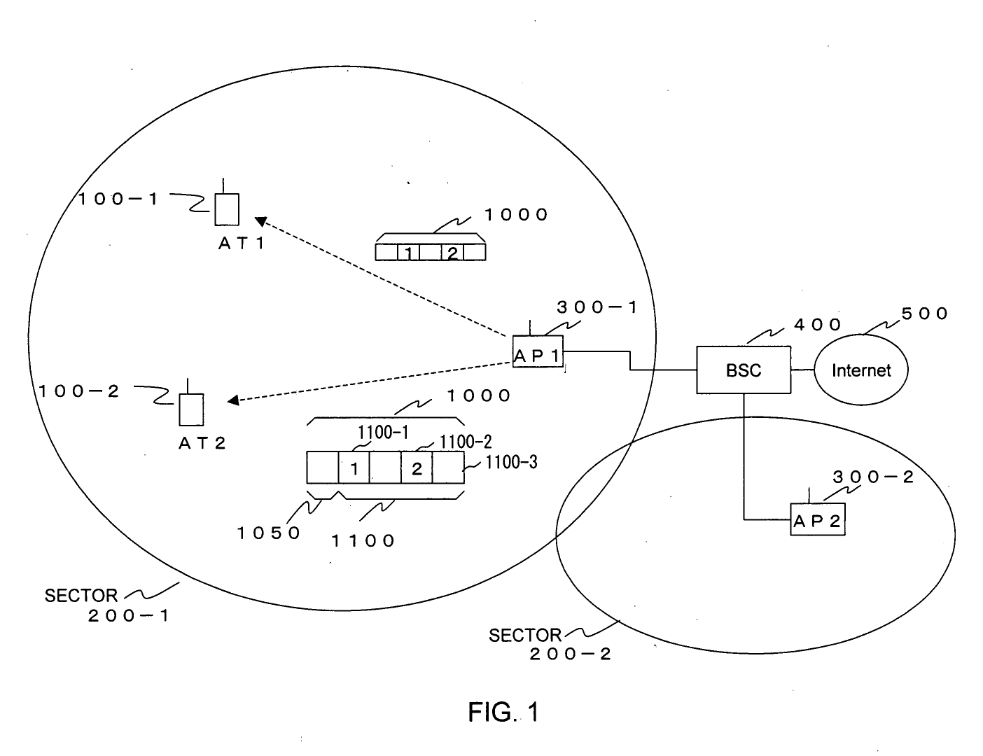

FIG. 1 shows an example structure of a mobile radio communication system according to an embodiment of the present invention. The mobile radio communication system is configured as described below and performs data communication. Not only a mobile radio communication system but also any radio communication system can be used.

The mobile radio communication system includes radio communication terminals (hereinafter called access terminals (ATs)) 100, radio base stations (hereinafter called access points (APs)) 300, and a base-station controller (BSCs) 400.

The ATs 100 establish radio communication paths to the APs 300. A radio area managed by each AP 300 is called a sector 200, and a plurality of ATs 100 can be connected to the AP 300 in each sector 200. To allow handover, adjacent sectors overlap as a sector 200-1 and a sector 200-2 shown in FIG. 1.

Each AP 300 is connected to the BSC 400 by wire connection. The BSC 400 can be connected to a plurality of APs 300, and is connected to an appropriate network 500, such as the Internet or a public communication network, by wire connection.

The ATs 100 and the APs 300 are connected through radio communication paths. A packet 1000 is sent, for example, from an AP 300 to an AT 100 through the radio communication path.

The packet 1000 includes a report-information area 1050 which includes the state of the AP 300 and various pieces of information required for the AT 100 to connect to the AP 300, and a communication-data (hereinafter called traffic-data) area 1100 actually handled by the user.

To perform data communication, the AT 100 first establishes a radio communication path to the AP 300 and connects to the AP 300. When the AP 300 receives a connection request from the AT 100, the AP 300 establishes a communication path to the BSC 400, and then, assigns a radio resource to the AT 100 and establishes a radio communication path.

When the radio communication path is established and data communication is ready, the AT 100 calculates the maximum transfer rate at which the AT 100 can receive data in its environment, and requests the transfer rate from the AP 300. For example, the AT 100 requests a transfer rate corresponding to a carrier-to-interference-power ratio (C/I). The AP 300 sends data at a rate corresponding to the transfer rate requested by the AT 100.

The report-information area 1050 and the traffic-data area 1100 are each formed of a plurality of slots, the slot being a time-divided unit, and each slot has a pilot signal 1200.

The traffic-data area 1100 is an area for storing user communication data, and stores data sent to a different user in each slot. When there is no user communication data to be stored, a slot is vacant, and the slot is called a “vacant slot” in the present embodiment.

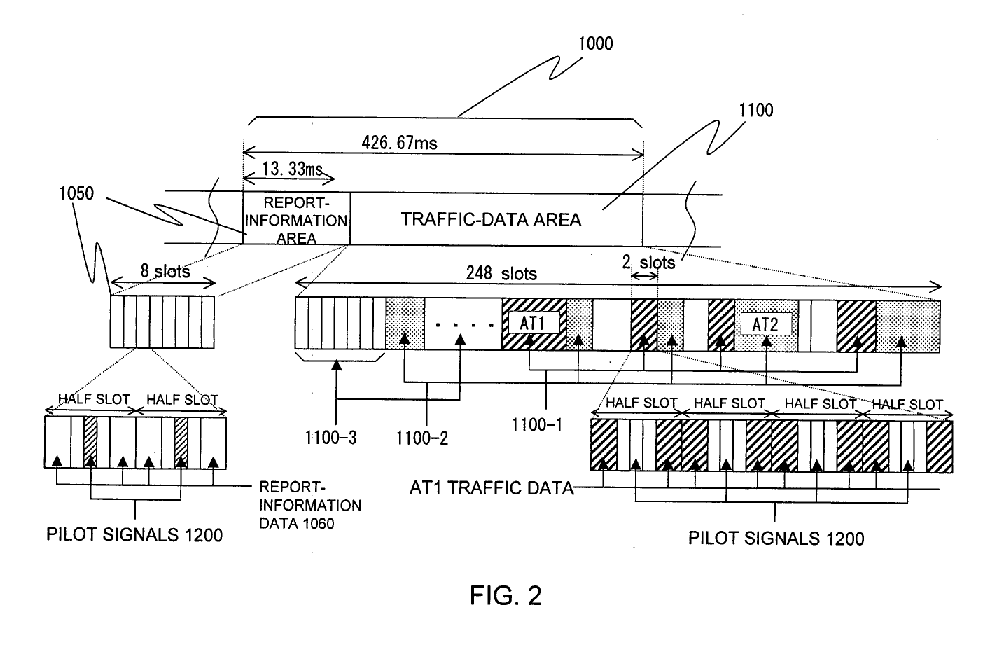

FIG. 2 shows an example structure of the packet 1000.

The packet 1000 is divided into the report-information area 1050 and the traffic-data area 1100. The report-information area 1050 and the traffic-data area 1100 are each time-divided, and formed of slots. One slot corresponds, for example, to 1/600 seconds (about 1.67 ms).

For example, the report-information area 1050 is formed of eight slots (or 16 slots), and the traffic-data area 1100 is formed of 248 slots (or 240 slots). The total of these 256 slots (corresponding to about 426.67 ms) is continuously sent and received as a cycle. A cluster formed of these 256 slots is called the packet 1000 in the present embodiment.

Each slot is a combination of two half slots. Each half slot has the pilot signal 1200 at its center. The pilot signal 1200 indicates received power at the AT 100, and is used to obtain the C/I value, which is a ratio between signal power sent from the AP 300 and other received power (or interference noise power).

Report-information data 1060 includes the number of users connected to the AP 300 and other pieces of radio information. The traffic-data area 1100 includes data sent to each user. The AP 300 determines a slot in which data sent to each user is stored. Each user data is assigned to a slot. A slot to which not user data is assigned is a vacant slot 1100-3, and traffic data is not included therein.

Data stored in each slot has been encoded by the AP 300, and correct data cannot be obtained unless the data in each slot is decoded by the key used in encoding. The key used when the AP 300 encodes data is sent to the AT 100 as one of radio resources, when the AT 100 establishes a radio communication path to the AP 300. With the use of the key, the AT 100 decodes the data.

FIG. 2 shows a case in which an AT1 100-1 and an AT2 100-2 are communicating with each other in the sector of an AP1 300-1 in FIG. 1. Therefore, the traffic-data area has an AT1 traffic-data area 1100-1, an AT2 traffic-data area 1100-2, and the vacant data area 1100-3.

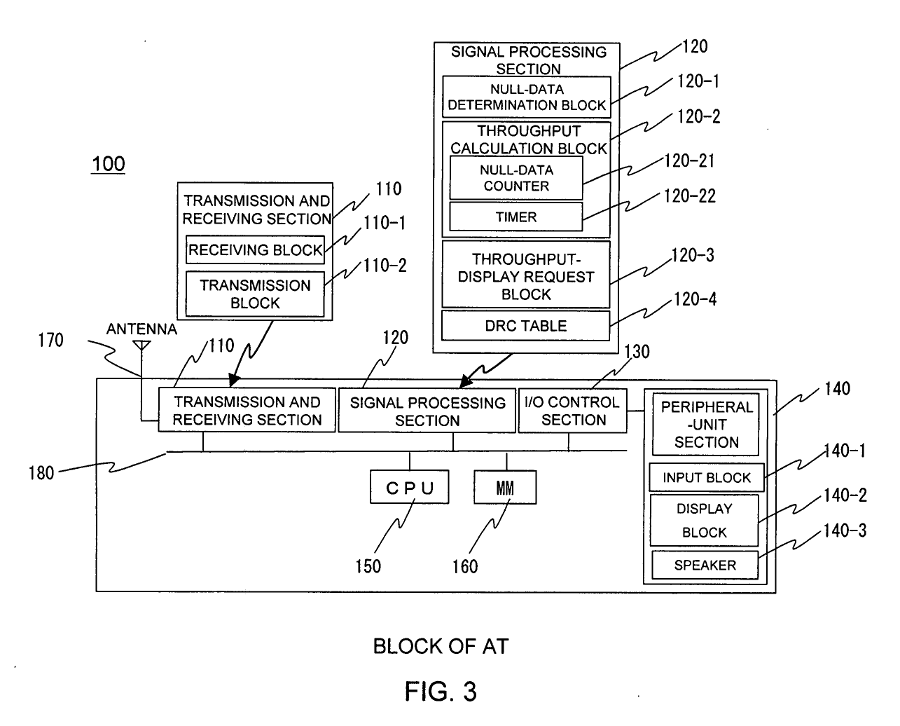

FIG. 3 is a block diagram of the AT 100. The AT 100 includes an antenna 170, a transmission and receiving section 110, a signal processing section 120, an I/O control section 130, a peripheral-unit section 140, a CPU 150, and a memory (MM) 160. Each section of the AT 100 is connected to each other, for example, through a bus 180. The AT 100 performs data communication with the AP 300 through a radio communication path.

The peripheral-unit section 140 includes, for example, an input block 140-1 formed of buttons for inputting data and instructions, a display block 140-2 including an LCD or an LED for displaying data and the intensity of radio-waves, and a speaker 140-3. The input block 140-1 may include appropriate input means, if necessary, such as a touch-sensitive panel, a mouse pointer, and a microphone in addition to or with the buttons. The display block 140-2 can display one or any combination of a value corresponding to the throughput calculated by the signal processing section 120, an image, base-station information, area information and communication-business-party information.

The transmission and receiving section 110 includes, for example, a transmission block 110-2 and a receiving block 110-1. The transmission block 110-2 sends a request transfer rate (such as DRC) calculated from a receiving-radio-wave condition (such as the C/I value) to the AP 300 through the antenna 170. The transmission block 110-2 also sends, for example, a signal (first signal) for requesting the transmission of null data (second signal) used for calculating the transfer rate to the AP 300 according to an instruction input of the operator while idling.

The receiving block 110-1 receives report information 1050 and traffic data 1100 from the AP 300 through the antenna 170. The receiving block 110-1 also receives null data used for calculating the transfer rate of the AP 300. The transmission and receiving section 110 performs modulation and demodulation such as those employing a phase shift keying (PSK) method to communicate with the AP 300.

The signal processing section 120 includes a null-data determination block 120-1 for determining the receiving of dummy data such as null data used for calculating the throughput such as the transfer rate, a throughput calculation block 120-2 for calculating the throughput according to null data, a throughput-display request block 120-3 for instructing the display block 140-2 to display the throughput calculated by the throughput calculation block 120-2, and a DRC table 120-4. In the present embodiment, appropriate data determined in advance as data not charged may be used in stead of null data.

The signal processing section 120 receives the report information 1050 and the traffic data 1100 received by the transmission and receiving section 110 through the antenna 170, and calculates an estimate throughput. In the present embodiment, the “estimate throughput” is a measurement value calculated from null data received at an idling state, and throughput predicted when usual data communication is actually performed.

The throughput calculation block 120-2 includes a null-data counter 120-21 for measuring the amount of received null data, and a timer 120-22 for measuring the time during which null data is received. The null-data counter 120-21 and the timer 120-22 may be independently provided separately from the throughput calculation block 120-2. In that case, the throughput calculation block 120-2 receives the data amount and the time from the null-data counter 120-21 and the timer 120-22 and calculates the throughput. When a null packet having a specified data size is sent, and an end notice is sent from the AP 300 after the transmission, it may be possible that the null-data counter 120-21 is omitted and the throughput is calculated by the specified data size and the receiving time measured by the timer 120-22.

A program for implementing a data communication function and data related to estimate-throughput calculation are stored in the storage unit MM 160. The MM 160 also serves as a processing work area.

The null-data determination block 120-1 determines whether data received by receiving means is null data or not. When the null-data determination block 120-1 detects null data, the null-data counter 120-21 counts the amount of information of the null data. The timer 120-22 measures the time from the time when the null-data counter starts counting the data. The timer 120-22 measures, for example, the time from when receiving of the null data is started to when the amount of information counted by the null-data counter 120-21 reaches the amount of information specified in advance, or the time from when receiving of the null data is started to when a null-data-transmission end notice is received from the AP 300. The throughput calculation block 120-2 calculates the transfer rate according to the amount of data counted by the null-data counter 120-21 and the time measured by the timer.

To request estimate-throughput calculation, the CPU 150 controls the transmission and receiving section 110, the signal processing section 120, and the MM 160 to send a null-data-transmission request to the AP 300 to calculate the estimate throughput. To display estimate throughput on the local unit, the throughput-display request block 120-3 instructs the display block 140-2 of the peripheral-unit section 140 through the I/O control section 130 to display the calculated estimate throughput. The CPU 150 controls the entire AT 100 to implement a data communication function.

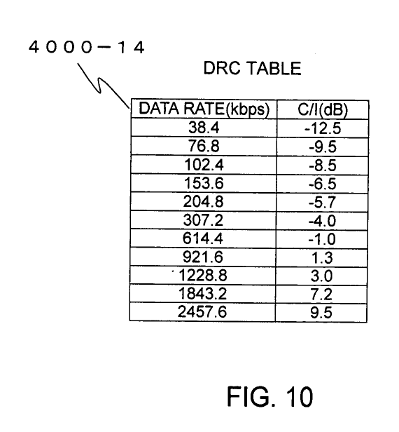

FIG. 10 shows an example structure of the DRC table 120-4. The DRC table 120-4 stores data rates (amount of transmitting data) and corresponding C/I values. The DRC table 120-4 may be provided for the MM 160 in addition to for the signal processing section 120.

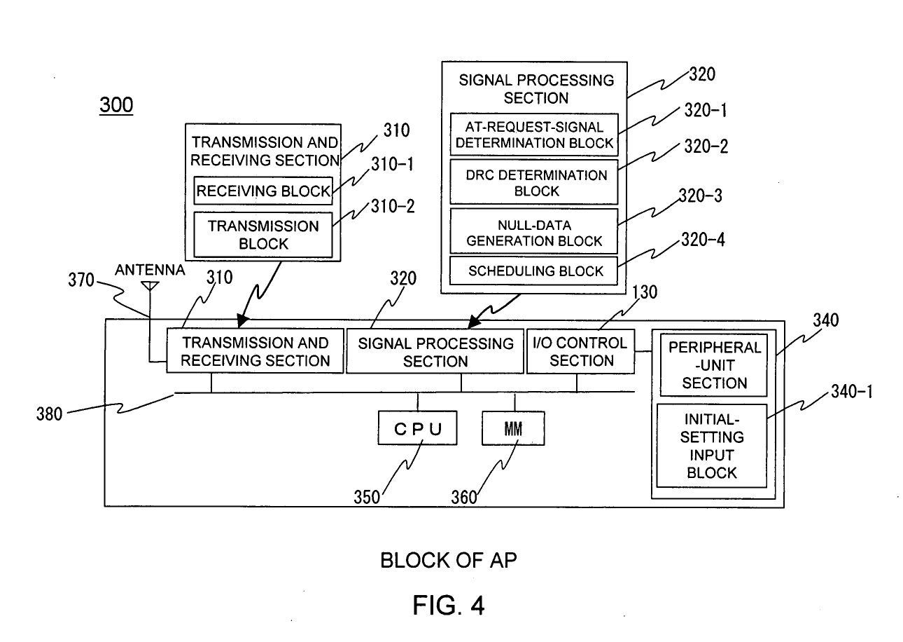

FIG. 4 is a block diagram of the AP 300.

The AP 300 includes an antenna 370, a transmission and receiving section 310, a signal processing section 320, an I/O control section 330, a peripheral-unit section 340, a CPU 350, and a memory (MM) 360. Each section of the AP 300 is connected to each other, for example, through a bus 380. The AP 300 performs data communication with the AT 100 through a radio communication path.

The signal processing section 320 receives a signal sent from the AT 100, through the transmission and receiving section 310. The signal processing section 320 includes an AT-request-signal determination block 320-1 for determining whether the received signal is a null-transmission-request signal or not, a DRC determination block 320-2 for determining DRC for a DRC request sent from the AT 100, a null-data generation block 320-3 for generating null data of a predetermined amount when the signal received from the AT 100 is a null-transmission-request signal, and a scheduling block 320-4 for instructing the transmission and receiving section 310 to store the generated null data and usual communication data into a time slot of a communication channel according to predetermined algorithm.

The peripheral-unit section 340 includes, for example, an initial-setting input block 340-1 for inputting initial values. The initial-setting input block 340-1 may be provided with a personal computer for inputting data and a keyboard, if necessary.

The transmission and receiving section 310 includes a receiving block 310-1 and a transmission block 310-2. The receiving block 310-1 receives the report information 1050 and the traffic data 1100 from the AT 100 through the antenna 370. The receiving block 310-1 also receives a request transfer rate and a null-transmission-request signal from the AT 100.

The transmission block 310-2 sends null data placed in a predetermined slot to the AT 100. The transmission and receiving section 310 performs modulation and demodulation such as those of a phase shift keying (PSK) method to communicate with the AT 100.

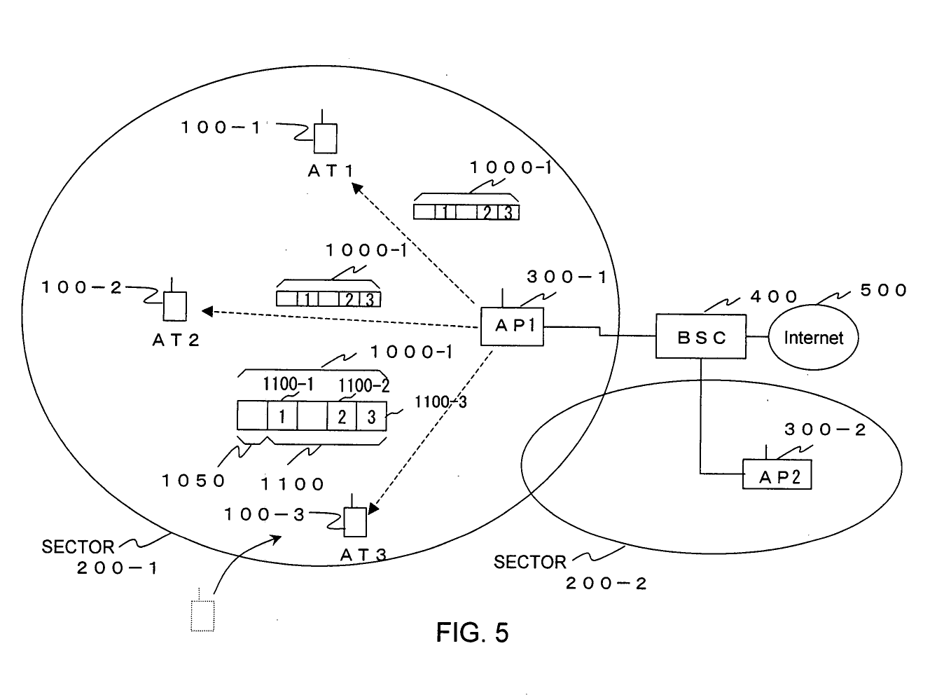

FIG. 5 shows an example structure of a mobile radio communication system according to the present embodiment. An AT3 100-3 is added to the structure shown in FIG. 1. In the mobile radio communication system shown in FIG. 5, the AT3 calculates throughput, for example, when the AT1 and the AT2 is communicating with the AP1. A packet 1000-1 has the same frame structure as the packet 1000 shown in FIG. 1. Null data sent to the AT3 100-3 is disposed in one slot of a vacant data area 1103.

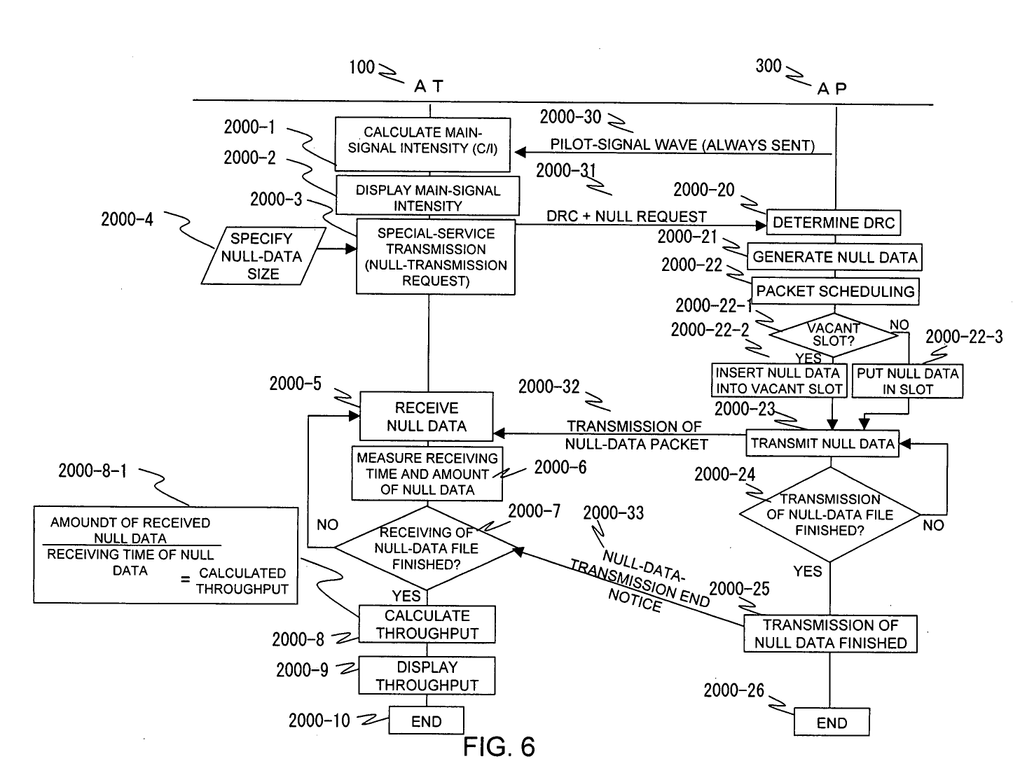

FIG. 6 is an example flowchart of a throughput calculation between the AT 100 and the AP 300. The flowchart shows a case in which the AT 100 sets the null-data size to a fixed value.

The AT 100 receives a pilot-signal wave 2000-30 sent from the AP 300, calculates a main-signal intensity (C/I value) in step 2000-1, and displays the main-signal intensity on the display block 140-2 of the AT 100 in step 2000-2.

To calculate throughput, the AT 100 sets the null-data size to a size determined in advance in step 2000-4, for example, according to the input of the operator, and sends DRC (data rate control, meaning a requested data rate) and a null-data-transmission request (first signal) 2000-31 to the AP 300 by special-service transmission in step 2000-3. The AT 100 can reference the DRC table 4000-14 to select a DRC corresponding to the calculated C/I value to send the selected DRC. The sent DRC may be not only a specific value (in kbps) but also appropriate identification information related to a DRC. The null-data-transmission request includes the specified data size.

The AP 300 receives the DRC and the null-data-transmission request. The AT-request-signal determination block 320-1 of the AP 300 monitors data received from the AT 100. When the AT-request-signal determination block 320-1 determines that the received data is a null-data-transmission request, the DRC determination block 320-2 determines a DRC in step 2000-20. For example, the DRC determination block 320-2 may use the DRC received from the AT 100 as is, or determines a DRC corresponding to the received identification information.

The AT-request-signal determination block 320-1 can determine that the received data is a null-data-transmission request because it receives a special-service transmission specified in advance. When the AT-request-signal determination block 320-1 determines that the received data is not a null-data-transmission request, the received data is regarded as a usual communication request or another service request and an appropriate process can be executed.

The null-data generation block 320-3 generates null data having the null-data size specified by the AT 100 and received by the AP 300, in step 2000-21. The null-data generation block 320-3 may hold the generated null data in an appropriate file (null-data file).

Then, the scheduling block 320-4 performs packet scheduling in step 2000-22. All terminals which are receiving downstream data are subjected to scheduling. Specifically, packet scheduling is performed not only for terminals (second radio communication terminals, such as the AT1 and AT2 in FIG. 5) which are communicating with the AP 300 but also for a terminal (first radio communication terminal, such as the AT3 in FIG. 5) from which a null-data transmission request has been received. For example, appropriate data or null data sent to the terminals which are communicating with the AP 300 and the terminal from which a null-data-transmission request has been received is assigned to each slot. In the present embodiment, terminals which are in communication does not include a terminal from which a null-data-transmission request has been received. Irrespective of whether there is a terminal from which a null-data-transmission request has been received, a scheduler operates, for example, as an EV-DO function. Example packet scheduling will be described later.

The scheduling block 320-4 references a result of scheduling to determine whether there is a vacant slot or not in step 2000-22-1. When the scheduling block 320-4 determines that there is a vacant slot in step 2000-22-1, the scheduling block 320-4 inserts the generated null data into the vacant slot in step 2000-22-2. In the present embodiment, if there is a vacant slot, scheduling assignment to a terminal from which a null-data-transmission request has been received can be performed with an active use of the vacant slot. Even if there is a vacant slot, the AP 300 operates in almost the same way as in a case in which a communication user is temporarily added. The vacant slot can be actively used.

When the scheduling block 320-4 determines that there is no vacant slot in step 2000-22-1, the scheduling block 320-4 puts the generated null data in a slot in step 2000-22-3. When there is no vacant slot, the scheduling block 320-4 applies, for example, the same scheduling as in a usual case in which a communication terminal is added, to the terminal from which a null-data-transmission request has been received, for a short period to temporarily perform the same putting-in scheduling as in a case in which one user is added. Even if there is no vacant slot, scheduling is performed as in a case in which one user is temporarily added, to reduce the area of another user to assign (to put in) the null data to a slot temporarily. Also in this case, example scheduling described later is effective. An appropriate putting-in method may be used.

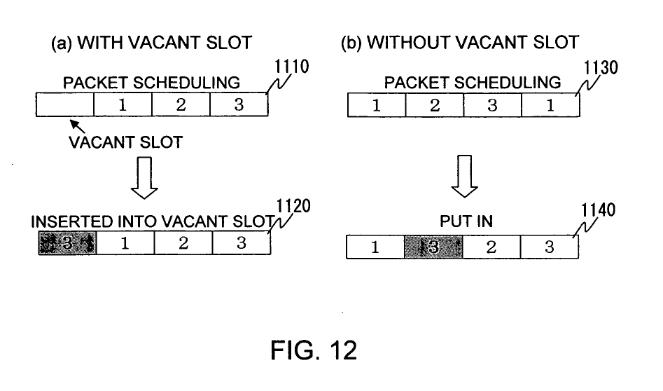

FIG. 12 is a view typically showing example packets in which null data is assigned to a slot. Slot assignment with a vacant slot and without a vacant slot will be described below. In the packets shown in FIG. 12, the report-information area 1050 is omitted, and only the traffic area 1100 is shown.

By the process in step 2000-22, described above, slots are assigned to the terminals (AT1 and AT2) which are communicating with the AP 300 and the terminal (AT3) from which a null-data-transmission request has been received, and, for example, a packet 1110 or a packet 1130 shown in FIG. 12 is obtained. The packet 1110 shows a case in which there is a vacant slot (FIG. 12A) and the packet 1130 shows a case in which there is no vacant slot (FIG. 12B).

When there is a vacant slot (in the case of the packet 1110), null data to be sent to the terminal (AT3) from which the null-data-transmission request has been received is inserted into the vacant slot to obtain a packet 1120 by the process in step 2000-22-2, described above.

When there is no vacant slot (in the case of the packet 1130), null data to be sent to the terminal (AT3) from which the null-data-transmission request has been received is placed in a slot to obtain a packet 1140 by the process in step 2000-22-3, described above.

Back to FIG. 6, the AP 300 sends the null data disposed in a slot to the AT 100 through the transmission and receiving section 310 in step 2000-23. The AT 100 receives the null data from the AP 300 through the transmission and receiving section 110 in step 2000-5. The null-data determination block 120-1 of the AT 100 monitors the null data received from the AP 300. When the null-data determination block 120-1 determines that the data sent from the AP 300 and received by the AT 100 is null data 2000-32, the null counter 120-21 of the AT 100 counts the amount of the received null data. The timer 120-22 starts measuring the receiving time of the null data in step 2000-6. The timer 120-22 starts counting the receiving time when it first receives null data. When the received null data is not null data first received, or when the timer 120-22 has already started measuring the receiving time, the timer 120-22 does not perform processing.

The AT 100 repeats null-data receiving until the receiving of the null-data file is completed, in steps 2000-5, 2000-6, and 2000-7. The AP 300 repeats transmission until the transmission of the generated null data is completed, in steps 2000-23 and 2000-24. When the transmission of the null data is completed in step 2000-25, the AP 300 sends a null-data-transmission end notice 2000-33 to the AT 100.

When the AT 100 receives the end notice 2000-33, the timer 120-22 stops measuring the time, and the throughput calculation block 120-2 calculates throughput in step 2000-8. The throughput is calculated by dividing the amount of the received null data by the receiving time of the null data in step 2000-8-1.
Calculated throughput=(amount of received null data)/(receiving time of null data)
The count of the null-data counter 120-21 may be used as the amount of the received null data. The specified data size may be used as the amount of the received null data. The time measured by the timer 120-22 may be used as the receiving time of the null data.

The calculated throughput is displayed on the display block 140-2 of the AT 100 by an instruction of the throughput-display request block 120-3 in step 2000-9. The signal processing section 120 may store the calculated throughput in the MM 160.

In the above description, the AT 100 calculates the throughput when the end notice 2000-33 is received. The AT 100 may calculate the throughput when null data having the data size specified in the process in step 2000-4 is received. For example, when the count of the null-data counter 120-21 reaches the specified data size, the AT 100 may calculate the throughput.

The AP 300 terminates the operation of the present processing in step 2000-26 after the null-data transmission is finished in step 2000-25. The AT 100 finishes the operation of the present processing in step 2000-10 after the AT 100 displays the throughput in step 2000-9. The display block 140-2 can display one or any combination of a value based on the throughput calculated by the signal processing section 120, an image, base-station information, area information, and communication-business-party information.

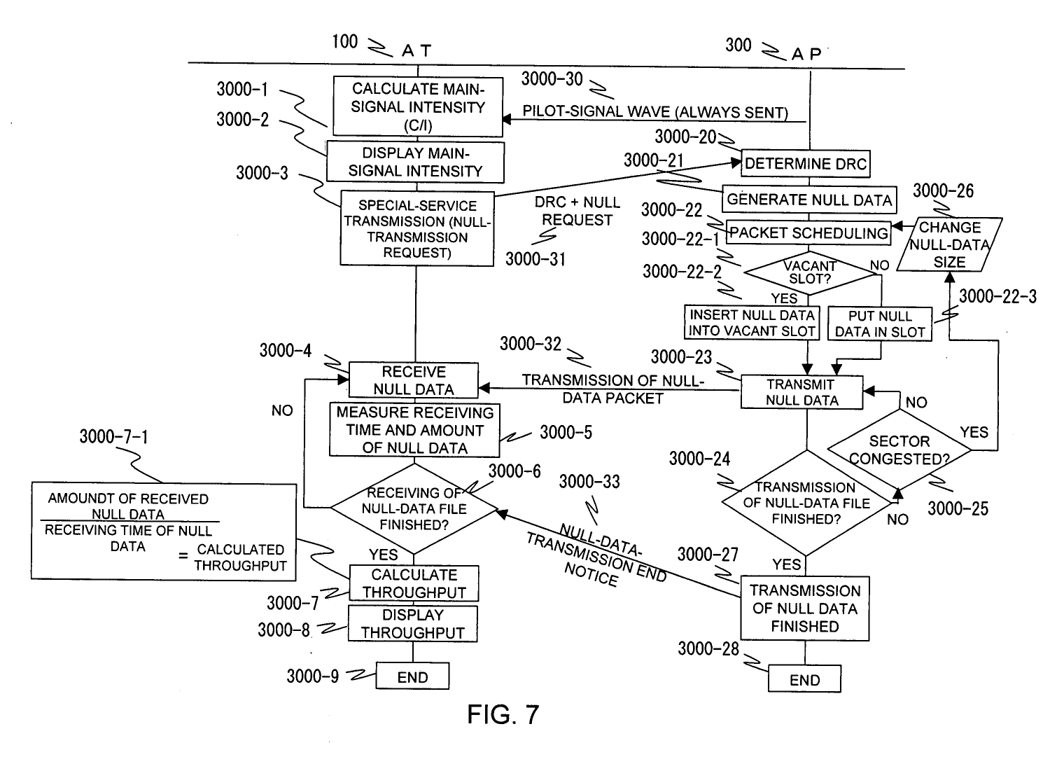

FIG. 7 is an example flowchart of a throughput calculation between the AT 100 and the AP 300. The flowchart shows a case in which a null-data size is not specified as a fixed value by the AT 100 but is made variable.

The AT 100 receives a pilot-signal wave 3000-30 sent from the AP 300, calculates a main-signal intensity (C/I value) in step 3000-1, and displays the main-signal intensity on the display block 140-2 of the AT 100 in step 3000-2.

To calculate throughput, the AT 100 sends DRC (requested data rate) and a null-data-transmission request 3000-31 to the AP 300 by special-service transmission in step 3000-3, for example, according to the input of the operator. The DRC is handled in the same way as in the process of step 2000-3 and as the DRC 2000-31, described above.

The AP 300 receives the DRC and the null-data-transmission request (first signal). The AT-request-signal determination block 320-1 of the AP 300 monitors data received from the AT 100. When the AT-request-signal determination block 320-1 determines that the received data is a null-data-transmission request, the DRC determination block 320-2 determines a DRC in step 3000-20.

The null-data generation block 320-3 generates null data having a size determined in advance, in step 3000-21. The null-data generation block 320-3 may hold the generated null data in an appropriate file (null-data file).

Then, the scheduling block 320-4 performs packet scheduling in step 3000-22. The scheduling block 320-4 references a result of scheduling to determine whether there is a vacant slot or not in step 3000-22-1. When the scheduling block 320-4 determines that there is a vacant slot in step S3000-22-1, the scheduling block 320-4 inserts the generated null data into the vacant slot in step 3000-22-2. When the scheduling block 320-4 determines that there is no vacant slot in step S3000-22-1, the scheduling block 320-4 puts the generated null data in a slot in step 3000-22-3. Since the details of the processes in step 3000-22 and steps 3000-22-1 to 3000-22-3 are the same as those in step 2000-22 and steps 2000-22-1 to 2000-22-3, a description thereof is omitted.

Then, the AP 300 sends the null data disposed in a slot to the AT 100 through the transmission and receiving section 310 in step 3000-23. The AT 100 receives the null data from the AP 300 through the transmission and receiving section 110 in step 3000-4. The null-data determination block 120-1 of the AT 100 monitors the null data received from the AP 300. When the null-data determination block 120-1 determines that the data sent from the AP 300 and received by the AT 100 is null data 3000-32, the null-data counter 120-21 of the AT 100 counts the amount of the received null data. The timer 120-22 starts measuring the receiving time of the null data in step 3000-5. The AT 100 repeats null-data receiving until the receiving of the null-data file is completed, in steps 3000-4, 3000-5, and 3000-6. The timer 120-22 starts counting the receiving time when it first receives null data. When the received null data is not null data first received, or when the timer 120-22 has already started measuring the receiving time, the timer 120-22 does not perform processing.

The AP 300 repeats transmission until the transmission of the generated null data is completed, in steps 3000-23 and 3000-24. During the repetition, the signal processing section 320 of the AP 300, for example, determines the congestion state of the sector 200-1 in step 3000-25. If the congestion state does not reach a threshold specified in advance, the transmission of null data is repeated in step 3000-23. If the congestion state reaches the threshold in step 3000-25, to reduce the transmission time, for example, the null-data size is changed (reduced or increased) in step 3000-26, the processing returns to the process in step 3000-22, and the transmission of null data having the changed size is continued in steps 3000-22 to 3000-24.

In general, the longer the receiving time of null data is, the higher the precision serving as the average throughput becomes. Even if there is always a vacant slot, the receiving time is finished in several milliseconds or several seconds. Therefore, the measuring time (null-data transmission time) is restricted by setting the amount of null data to be transmitted, according to the DRC.

The congestion state of a sector can be determined (in step 3000-25), for example, by the number of ATs which are in communication in the sector and the radio-wave conditions of the ATs which are in communication. The signal processing section 320 determines, for example, that the more ATs having a good radio-wave condition are in communication in a sector, the more the sector is congested. For example, when the number of ATs 100 having a radio-wave condition better than a predetermined threshold is greater than a predetermined value in a sector, the sector is determined to be congested, and in the other cases, the sector is determined to be not congested. The signal processing section 320 may determine a reduction in the size of null data according to the congestion state. When the transmission of the null data is completed in step 3000-27, the AP 300 sends a null-data-transmission end notice 3000-33 to the AT 100.

When the AT 100 receives the end notice 3000-33, the throughput calculation block 120-2 calculates throughput in step 3000-7. The throughput is calculated by dividing the amount of the received null data by the receiving time of the null data in step 3000-7-1.
Calculated throughput=(amount of received null data)/(receiving time of null data)
The count of the null-data counter 120-21 may be used as the amount of the received null data. The time measured by the timer 120-22 may be used as the receiving time of the null data.

The calculated throughput is displayed on the display block 140-2 by an instruction of the throughput-display request block 120-3 in step 3000-8. The signal processing section 120 may store the calculated throughput in the MM 160.

The AP 300 terminates the operation of the present processing in step 3000-28 after the null-data transmission is finished in step 3000-27. The AT 100 finishes the operation of the present processing in step 3000-9 after the AT 100 displays the throughput in step 3000-8. The display block 140-2 can display one or any combination of a value based on the throughput calculated by the signal processing section 120, an image, base-station information, area information, and communication-business-party information.

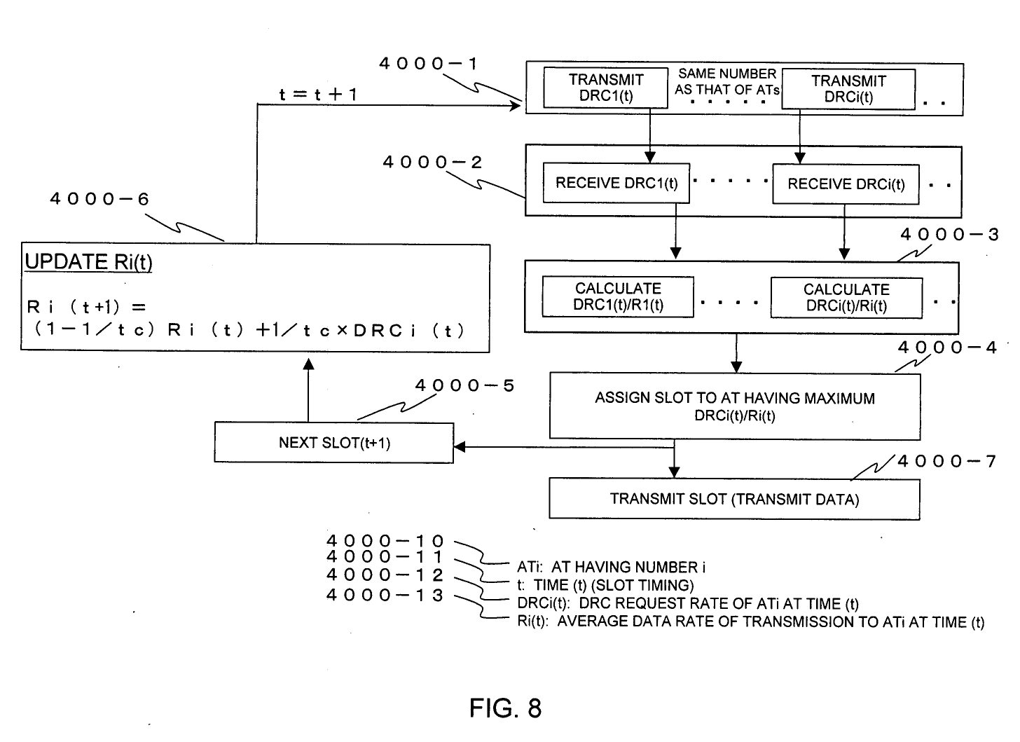

FIG. 8 is a flowchart 4000 of a proportional-fair packet-scheduling algorithm, which is typical in packet scheduling algorithm.

In 1×EX-DO, an active Ati 4000-10 determines the transfer rate of data to be received, according to a measured C/I value, and sends a requested data rate DRCi(t) 4000-1 to the AP 300 in step 4000-1, where “i” indicates an integer from 1 to n, ATs which are communicating with the AP are called AT1, AT2, . . . , ATi, . . . , and ATn, and “n” is the number of ATs which are communication with the AP.

The signal processing section 120 of the AT 100 has the DRC table 120-4, and the AT 100 determines the transfer rate from the measured C/I value according to the table.

The DRCi(t) 4000-12 is updated at an interval of 1.67 ms (600 Hz). When the schedular (scheduling block 320-4) assigns a slot to the ATi 4000-10 under certain algorithm, the ATi 4000-10 sends data at a transfer rate corresponding to the DRCi(t) 4000-12 at timing 1.5 slots later than the transmission timing of the DRCi(t) 4000-12.

When the schedular uses channel-quality fluctuation in time to give priority to an ATi 4000-10 which send the DRCi(t) 4000-12 to request high-speed transfer to assign a transmission slot to it, the sector throughput of the system is improved. The schedular, called a professional fair, basically starts transmission to an ATi 4000-10 having a higher DRCi(t) 4000-12 first when a plurality of ATi 4000-10 conflict with each other. Depending on the radio-wave propagation condition and the frequency of the data transmission request of ATi 4000-10, however, a slot is assigned to a specific ATi 4000-10 having a high DRCi(t) 4000-12 and transmission is performed whereas a slot is usually not assigned to an ATi 4000-10 having a low DRCi(t). This state is inconvenient for the ATi having a low DRCi(t), and should be considered. Taking into account the amount of data already sent in a past certain period to an ATi 4000-10 to which transmission is to be made, the schedular determines an ATi 4000-10 to which transmission is made in the next slot.

When ATi 4000-10 sends DRCi(t) at time t 4000-11 in step 4000-1, the schedular receives the DRCi from each ATi in step 4000-2. The schedular uses the average data rate (amount of transmitting data) Ri(t) 4000-13 for ATi 4000-10 for a past certain period to obtain DRCi(t)/Ri(t) of ATi 4000-10 in step 4000-3. The shedular performs similar operation for other AT which receives DRCi(t) 4000-12. The schedular assigns the next transmission slot to an ATi having the maximum DRCi(t)/Ri(t) in step 4000-4. Data to be sent to the ATi to which the transmission slot has been assigned is inserted into the slot and transmitted in step 4000-7.

The Ri(t+1) of ATi is updated according to the following equation at time t+1 in step 4000-6.
Ri(t+1)=(1−1/tc)×Ri(t)+1/tc×DRCi(t)
where a time constant tc is obtained when the amount of data already sent for a past certain period is taken into account. The schedular executes the processes in steps 4000-1 to 4000-7 by setting time t=t+1. An appropriate method other than that shown in FIG. 8 can be used.

The occurrence of a vacant slot will be described below.

(1) Case 1 (Vacant Slot in AT Dormant Mode)

The EV-DO method is a kind of a radio infrastructure for Internet connections, and it is expected that AT users repeats receiving and browsing of web sites. It is thought that even an AT which is in communication does not always receive data and is substantially in idling. This state is called dormant mode. The internal processing of an AP handles this mode in the same way as for an idling terminal which is turned on in a sector but not in communication. Since a high-rate-communication DRC is assigned to a terminal having a good radio characteristic, the downloading time become shorter due to the high data rate (amount of transmitting data), and a vacant time is expected. Even when there is a plurality of ATs which are in communication in a sector, it is thought that a vacant data slot is likely to occur if the sector is not congested.

(2) Case 2 (Vacant Slot Due to Intermittent Data Receiving)

An AT receives data sent from an AP through an IP communication network. Due to IP-transfer characteristics, it is thought that, even when the AT receives a cluster of web-site data, server data is not continuously but intermittently sent to the AT (received by the AT). This state also generates a vacant slot.

(3) Case 3 (Vacant Slot Due to Data Rate (Amount of Transmitting Data) Lower than Threshold)

An AT having a bad radio condition may have a C/I value lower than that corresponding to a lowest DRC rate of 38.4 kbps (in the case of the DRC table 4000-14). In that case, no assignment is made and a vacant slot is generated. In EV-DO method, a temporarily bad radio-wave characteristic and an in-tunnel state are taken into account, and a function for holding a channel alive for a predetermined number of seconds without turning off the channel immediately is provided.

(4) Case 4 (Vacant Slot Caused by EV-DO Specifications)

It is thought that a vacant slot may be generated due to the packet transfer characteristic specified in Chapter 9 of 3GPP2 C. S0024, which is the standardized EV-DO specifications. It is thought that this is caused by a plurality of reasons, but the issue is confirmed by numerical simulation and actual experimental data.

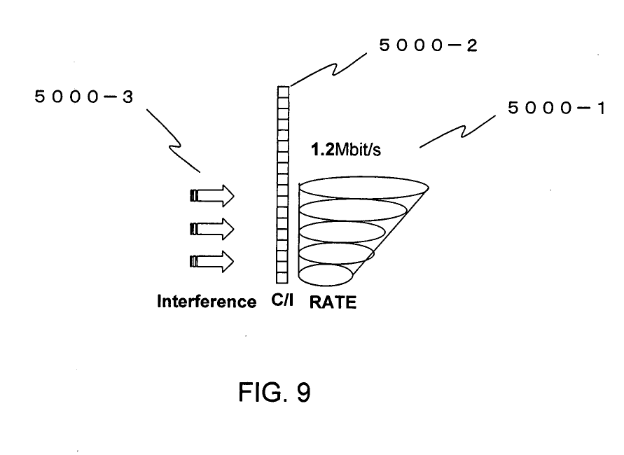

FIG. 9 shows an example display of a calculated throughput in the AT 100. This example display includes a combination of a rate indication 5000-1, a C/I indication 5000-2, and an interference indication 5000-3. The rate indication 5000-1 shows a numerical throughput, and circles or ellipses. The higher the throughput is, the larger the top circle or ellipse becomes, to express a thick data-communication path.

The C/I indication 5000-2 shows a bar. The higher the receiving level of a main signal is, the longer the bar becomes, to indicate a better receiving condition. The interference indication 5000-3 shows an arrow or arrows. The higher the intensity of interference waves (disturbance waves) other than the main signal is, the greater the number of arrows becomes, to visually indicate a factor of throughput reduction.

An appropriate method other than figure may be used to display the calculated throughput. Any combination of the rate indication 5000-1, the C/I indication 5000-2, and the interference indication 5000-3 may be displayed.

First Modification

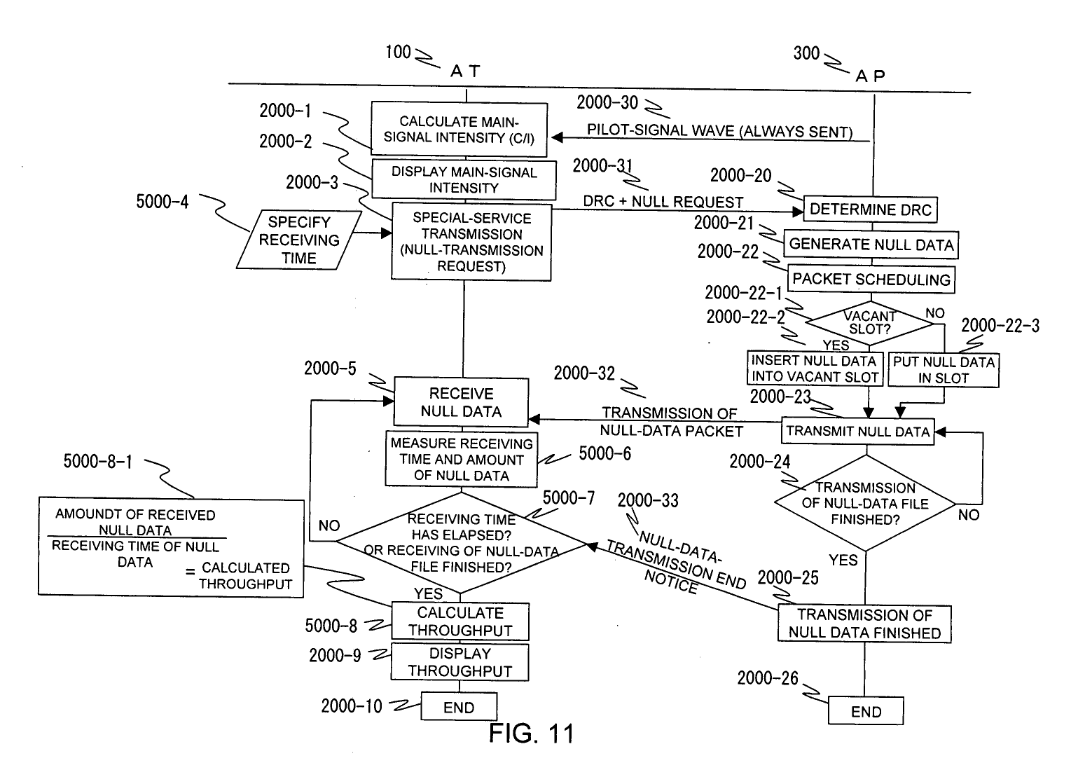

FIG. 11 is a flowchart of a throughput calculation between the AT 100 and the AP 300 according to a modification. The flowchart shows a modification of the processing shown in FIG. 6, and the AT 100 calculates throughput when a time determined in advance elapses from the start of null-data receiving. The same processes as those shown in FIG. 6 are assigned the same numerals as those used in FIG. 6, and a description thereof is omitted.

The AT 100 first performs the process in step 2000-1 and the process in step 2000-2. To calculate throughput, the AT 100 sets the receiving time to a time determined in advance in step 5000-4, for example, according to the input of the operator, and sends a DRC and a null-data-transmission request 2000-31 to the AP 300 by special-service transmission in step 2000-3. The AP 300 executes the processes in steps 2000-20 to 2000-24.

The AT 100 receives the null data in step 2000-5. When the null-data determination block 120-1 determines that the data sent from the AP 300 is null data 2000-32, the null counter 120-21 of the AT 100 counts the amount of the received null data in 5000-6. The timer 120-22 starts measuring the receiving time of the null data in step 5000-6.

The AT 100 repeats null-data receiving in steps 2000-5, 5000-6, and 5000-7 until the measuring time of the timer 120-22 reaches a specified receiving time. When the AT 100 receives a null-data-file-transmission end notice before the measuring time reaches the specified receiving time, the AT 100 may stop receiving the null data and proceed to the process in step 5000-8.

The AP 300 repeats transmission in steps 2000-23 and 2000-24 until the transmission of the generated null data is completed. When the transmission of the null data is completed in step 2000-25, the AP 300 may send a null-data-transmission end notice 2000-33 to the AT 100.

When the specified receiving time elapses, or when the end notice 2000-33 is received, the AT 100 stops time counting performed by the timer 120-22 and calculates throughput in the throughput calculation block 120-2 in step 5000-8. The throughput is calculated by dividing the amount of the received null data by the receiving time of the null data in step 5000-8-1.
Calculated throughput=(amount of received null data)/(receiving time of null data)

The count of the null-data counter 120-21 may be used as the amount of the received null data. The time measured by the timer 120-22 may be used as the receiving time of the null data. The specified receiving time may be used as the null-data receiving time. Then, the AT 100 executes the process in step 2000-9, and terminates the processing. The AP 300 also terminates the processing.

The processing shown in FIG. 11 is a modification of the processing shown in FIG. 6. In the same way, the processing shown in FIG. 7 may be modified.

Second Modification

The processes in steps 2000-22 to 2000-22-3 performed by the AP 300 may be modified and executed as processes in steps 2000-22′ to 2000-22-3′, as described below.

The scheduling block 320-4 applies packet scheduling in step 2000-22′ to terminals (such as AT1 and AT2 in FIG. 5) which are actually communicating with the AP 300, other than a terminal (such as AT3 in FIG. 5) from which a null-data-transmission request has been received. In addition to the processing shown in FIG. 8, an appropriate method can be used as packet scheduling. With this, slots are assigned to terminals (such as AT1 and AT2) which are actually communicating with the AP 300.

The scheduling block 320-4 references a result of scheduling to determine whether there is a vacant slot or not in step 2000-22-1′. When the scheduling block 320-4 determines that there is a vacant slot in step S2000-22-1′, the scheduling block 320-4 inserts the generated null data into the vacant slot (such as slot 1100-3 in FIG. 1) in step 2000-22-2′.

When the scheduling block 320-4 determines that there is no vacant slot in step 2000-22-1′, the scheduling block 320-4 puts the generated null data in a slot in step 2000-22-3′. For example, the scheduling block 320-4 applies packet scheduling to the terminal (such as AT3) from which a null-data-transmission request has been received, and to terminals (such as AT1 and AT2) which are actually communicating with the AP 300 in a way in which one user (a communication terminal) is added. Even if there is no vacant slot, scheduling is performed as in a case in which one user is temporarily added, to reduce the area of another user to assign (to put in) the null data to a slot temporarily. The same modification as that described above is possible for the processes in steps 3000-22 to 3000-22-3.

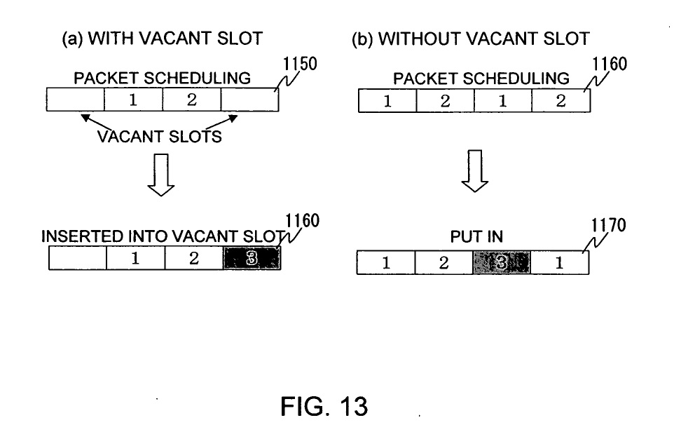

FIG. 13 is a view typically showing example packets in which null data is assigned to a slot, in the present modification. In the packets shown in FIG. 13, the report-information area 1050 is omitted, and only the traffic area 1100 is shown.

By the process in step 2000-22′, described above, slots are assigned to the terminals (AT1 and AT2) which are communicating with the AP 300 and, for example, a packet 1150 or a packet 1170 shown in FIG. 13 is obtained. The packet 1115 shows a case in which there is a vacant slot and the packet 1170 shows a case in which there is no vacant slot.

When there is a vacant slot (in the case of the packet 1150), null data to be sent to the terminal (AT3) from which the null-data-transmission request has been received is inserted into the vacant slot to obtain, for example, a packet 1160 by the process in step 2000-22-2′, described above.

When there is no vacant slot (in the case of the packet 1170), null data to be sent to the terminal (AT3) from which the null-data-transmission request has been received is placed in a slot to obtain, for example, a packet 1180 by the process in step 2000-22-3′, described above.

Third Modification

In the above description, processing for one AP 300 performed while an AT is in idling is shown. When an AT can communicate with a plurality of APs, such as a case in which an AT 100 is located in a zone where sectors overlap, the above-described processing may be sequentially executed for the plurality of APs. When an AT receives radio waves from a plurality of APs, the above-described processing may be executed for an AP from which the maximum received power is obtained or for APs from which received power higher than a predetermined value is obtained.

1. A radio communication terminal comprising:
a transmission section for transmitting a first signal to a radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate a transfer rate expected when the radio communication terminal is connected to the radio base station through a radio communication path;
a receiving section for receiving the second signal or the plurality of second signals transmitted from the radio base station in response to the first signal; and
a signal processing section for calculating, when the receiving section has received the second signal or the plurality of second signals having the amount of information corresponding to the first signal, the transfer rate according to the time required from when receiving of the second signal is started to when the amount of information is reached, and the amount of information of the second signal received; or for calculating, when the receiving section has received an end notice of the transmission of the second signal from the radio base station, the transfer rate according to the time required from when receiving of the second signal is started to when the end notice of the transmission is received, and the amount of information of the second signal received.

2. A radio communication terminal comprising:
a transmission section for transmitting a first signal to a radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate a transfer rate expected when the radio communication terminal is connected to the radio base station through a radio communication path;
a receiving section for receiving the second signal or the plurality of second signals transmitted from the radio base station in response to the first signal; and
a signal processing section for calculating, when a time specified in advance has elapsed from when the receiving section starts receiving the second signal, the transfer rate according to the amount of information of the second signal received until the time specified in advance elapses, and the time specified in advance.

3. A radio communication terminal according to one of claims 1 and 2, wherein the second signal is null data or data specified in advance as data not subjected to accounting.

4. A radio communication terminal according to claim 1,
wherein the signal processing section comprising:
a determination block for determining whether a signal or data received by the receiving section is the second signal;
a counter for counting the amount of information of the second signal determined by the determination block;
a timer for measuring either a time from the start of receiving of the second signal to when the amount of information counted by the counter reaches an amount of information specified in advance, or a time from the start of receiving of the second signal to when the receiving section receives the end notice of the transmission of the second signal; and
a throughput calculation block for calculating the transfer rate according to the amount of information counted by the counter and the time measured by the timer.

5. A radio communication terminal according to claim 2,
wherein the signal processing section comprising:
a determination block for determining whether a signal or data received by the receiving section is the second signal;
a counter for counting the amount of information of the second signal determined by the determination block;
a timer for measuring a time from the start of receiving of the second signal; and
a throughput calculation block for calculating, when the time measured by the timer indicates a time specified in advance, the transfer rate according to the amount of information counted by the counter, and the time specified in advance or the time measured by the timer.

6. A radio communication terminal according to one of claims 1 and 2, further comprising:
a display section for displaying one or any combination of a value based on the transfer rate calculated by the signal processing section, an image, base-station information, area information, and communication-business-party information.

7. A radio base station in a radio communication system in which a data area for storing communication data is formed of a plurality of slots time-divided, data or a signal to be sent to each radio communication terminal is assigned to a slot, and the radio base station transmits data or a signal to each radio communication terminal, the radio base station for calculating a transfer rate expected when a radio communication terminal in an idling state is connected to the radio base station through a radio communication path, the radio base station comprising:
a receiving section for receiving a first signal from the radio communication terminal, the first signal requesting the transmission of a second signal used to calculate the transfer rate expected when the radio communication terminal is connected to the radio base station through the radio communication path;
a signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the receiving section has received the first signal; and
a transmission section for transmitting the second signal or a plurality of second signals generated by the signal processing section to the radio communication terminal.

8. A radio base station according to claim 7,
wherein the signal processing section comprises:
a signal determination block for determining a signal received by the receiving section is the first signal;
a data generation block for generating the second signal having the amount of information corresponding to the first signal or having the amount of information specified in advance when the signal determination block has determined that the signal received is the first signal; and
a scheduling block for performing packet scheduling in which data or the second signal to be sent to a first radio communication terminal from which the first signal has been received and to a second radio communication terminal which is communicating with the radio base station is assigned to each slot, and for referencing a result of scheduling to further insert the second signal generated by the data generation block to a vacant slot for transmission to the first radio communication terminal if there is the vacant slot, or to further put the second signal in a slot for transmission to the first radio communication terminal when there is no vacant slot, and
the transmission section transmits the second signal to the first radio communication terminal according to an instruction of the scheduling block.

9. A radio base station according to claim 7,
wherein the signal processing section determines whether a sector managed by the radio base station is more congested than a state specified in advance, according to the number of second radio communication terminals which are communication with the radio base station and/or the radio-wave conditions of the second radio communication terminals while the second signal is being transmitted,
changes the amount of information of the generated second signal when it is determined that the sector is more congested,
assigns the second signal having the changed amount of information to a predetermined slot and transmits the second signal, and
transmits a transmission end notice to the first radio communication terminal from which the first signal has been received, after the transmission of the second signal having the changed amount of information is finished.

10. A radio communication system in which a data area for storing communication data is formed of a plurality of slots time-divided, data or a signal to be sent to each radio communication terminal is assigned to a slot, and a radio base station transmits data or a signal to each radio communication terminal, the radio communication system for calculating a transfer rate expected when a radio communication terminal in an idling state is connected to the radio base station through a radio communication path,
the radio communication terminal comprising:
a first transmission section for transmitting a first signal to the radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate the transfer rate expected when the radio communication terminal is connected to the radio base station through the radio communication path;
a first receiving section for receiving the second signal or the plurality of second signals transmitted from the radio base station in response to the first signal; and
a first signal processing section for calculating, when the first receiving section has received the second signal or the plurality of second signals having the amount of information corresponding to the first signal, the transfer rate according to the time required from when receiving of the second signal is started to when the amount of information is reached, and the amount of information of the second signal received; or for calculating, when the first receiving section has received an end notice of the transmission of the second signal from the radio base station, the transfer rate according to the time required from when receiving of the second signal is started to when the end notice of the transmission is received, and the amount of information of the second signal received, and
the radio base station comprising:
a second receiving section for receiving the first signal from the radio communication terminal, the first signal requesting the transmission of the second signal;
a second signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the second receiving section has received the first signal; and
a second transmission section for transmitting the second signal or a plurality of second signals generated by the second signal processing section to the radio communication terminal.

11. A radio communication system in which a data area for storing communication data is formed of a plurality of slots time-divided, data or a signal to be sent to each radio communication terminal is assigned to a slot, and a radio base station transmits data or a signal to each radio communication terminal, the radio communication system for calculating a transfer rate expected when a radio communication terminal in an idling state is connected to the radio base station through a radio communication path,
the radio communication terminal comprising:
a first transmission section for transmitting a first signal to the radio base station while the radio communication terminal is in an idling state, to request the transmission of a second signal or a plurality of second signals having the amount of information corresponding to the first signal or having the amount of information specified by the radio base station, the second signal or the plurality of second signals being used to calculate the transfer rate expected when the radio communication terminal is connected to the radio base station through the radio communication path;
a first receiving section for receiving the second signal or the plurality of second signals transmitted from the radio base station in response to the first signal; and
a first signal processing section for calculating, when a time specified in advance has elapsed from when the first receiving section starts receiving the second signal, the transfer rate according to the amount of information of the second signal received until the time specified in advance elapses, and the time specified in advance, and
the radio base station comprising:
a second receiving section for receiving the first signal from the radio communication terminal, the first signal requesting the transmission of the second signal;
a second signal processing section for generating the second signal having the amount of information corresponding to the first signal or having an amount of information specified in advance, and for inserting the generated second signal into a vacant slot for transmission to the radio communication terminal if there is the vacant slot, or for putting the generated second signal in a slot for transmission to the radio communication terminal if there is no vacant slot, when the second receiving section has received the first signal; and
a second transmission section for transmitting the second signal or a plurality of second signals generated by the second signal processing section to the radio communication terminal.
